(19) United States
(12) Patent Application Publication
(10) Pub. No.: US 2009/0282976 A1
(43) Pub. Date: Nov. 19, 2009

(54) METHANE GAS DISPOSAL AND USE VIA SUBSURFACE DRIP IRRIGATION TECHNIQUES

(76) Inventor: Rodney Ruskin, San Rafael, CA (US)

Correspondence Address: CHRISTIE, PARKER & HALE, LLP, PO BOX 7068, PASADENA, CA, 91109-7068, US

(21) Appl. No.: 12/465,360

(22) Filed: May 13, 2009

Related U.S. Application Data
(60) Provisional application No. 61/127,537, filed on May 13, 2008.

(51) Int. Cl. B01D 47/00

(52) U.S. Cl. 95/151; 96/243; 96/255; 95/149

(57) ABSTRACT

Greenhouse gas emissions containing methane are collected at the source and dispersed into the soil via subsurface drip irrigation techniques. In one embodiment, methane gas generated from anaerobic digestion in a septic tank, such as a decentralized septic system, is disposed of via a subsurface wastewater disposal system. Secondary-treated wastewater effluent from the septic tank and the air/methane gas drawn from above the septic tank can be alternately pumped downstream to a drain field containing a time-dosed dispersal system comprising drip irrigation emitters in downstream driplines. Alternatively, the air/methane gas can be simultaneously drawn from the septic tank and injected into the pressure flow of wastewater effluent via a venturi-type mixer-injector. The methane gas pumped through the drip system into the soil can oxidize and break down into carbon dioxide as one of its by-products. The subsurface methane gas disposal system may be used in combination with subsurface irrigation of plants or vegetation which can usefully absorb the carbon dioxide by-product.

### CROSS-REFERENCE TO RELATED APPLICATION

This application claims the benefit of and priority to U.S. Provisional Application No. 61/127,537, filed on May 13, 2008, the contents of which are fully incorporated herein by this reference.

### FIELD OF THE INVENTION

This invention relates to disposal of methane gas using subsurface drip irrigation dispersal techniques. Methane gas which is emitted from a variety of human-related sources is captured, rather than being released into the atmosphere. The subsurface disposal of the methane gas has beneficial uses as well as reducing the environmental problems associated with excess greenhouse gases, of which methane gas is a principal component.

### BACKGROUND

Greenhouse gases are the gases present in the atmosphere which reduce the loss of heat into space and therefore contribute to global temperatures through the greenhouse effect.

On Earth, the most abundant greenhouse gases are, in order of relative abundance:
water vapor;
carbon dioxide;
methane;
nitrous oxide;
ozone; and
CFCs.

The most powerful greenhouse gases are:
water vapor, which causes about 36-70% of the greenhouse effect on Earth;
carbon dioxide, which causes 9-26%;
methane, which causes 4-9%; and ozone, which causes 3-7%.

Sources of greenhouse gases due to human activity include: livestock enteric fermentation and manure management, paddy rice farming, land use and wetland changes, pipeline losses, and covered vented landfill emissions leading to higher methane atmospheric concentrations. Many of the newer style fully vented septic systems that enhance and target the fermentation process also are sources of atmospheric methane.

Methane is produced by anaerobic digestion, as takes place in a septic tank.

According to the EPA, wastewater treatment processes produce 1.2 Tg (1 Tg=1 million Mg=1,000,000,000 Kg) of methane per annum.

Methane has a greenhouse gas equivalent 21 times stronger than carbon dioxide.

A large part of the methane produced in municipal wastewater treatment plants is collected and used.

It is not practical to collect and use the methane produced in a small on-site or decentralized system septic tank.

In the USA as much as 40% of the sewage is treated on-site or in decentralized systems.

On-site and decentralized septic systems have many environmental advantages over centralized wastewater treatment plants; however greenhouse gas emission is a major environmental disadvantage.

### SUMMARY OF THE INVENTION

Briefly, one embodiment of the invention comprises a system for disposing of methane gas emissions so as to reduce the amount of methane gas which would otherwise be dispersed into the atmosphere from the source. The system includes collecting the methane gas emissions at the source and disposing of the gas into the soil in a subterranean disposal area. The source of methane gas emissions can be various types of sources that result in biogas emissions containing methane, which are generated from human activities and often dispersed into the atmosphere as greenhouse gas emissions. The methane gas emissions are collected from the source and transmitted under pressure from the source and dispersed into the soil via a subsurface drip irrigation dispersal system. The dispersal system can contain buried dripline tubing containing spaced apart drip irrigation type emitters or other devices that can disperse the gas into the soil without clogging or otherwise interfering with transmission of the methane gas between the source and the subterranean disposal area. In the disposal area, the methane is broken down, and carbon dioxide, as one of its by-products, can be usefully absorbed into plants or vegetation otherwise being irrigated by the drip irrigation system.

One embodiment of the present invention specifically addresses the problems of greenhouse gas emissions from anaerobic digesters, wastewater treatment systems, or septic systems. The invention comprises a system for disposing of methane gas contained in septic tanks or other anaerobic digestion systems which can include treated wastewater effluent and methane gas in the air contained within the septic tank. The wastewater effluent is pumped from the septic tank and the effluent is dispersed into the soil at a subsurface disposal area, via a subsurface dispersal system. The air/methane gas is separately drawn from the interior of the septic tank and injected into the wastewater disposal system to dispose of the methane gas through the subsurface dispersal system. The subsurface dispersal system comprises a system of dripline tubing with spaced apart drip irrigation-type emitters positioned in the soil in the subsurface disposal area.

Timed-dosing or discontinuous dispersal techniques can be used for alternately delivering the wastewater effluent and the methane gas to the disposal area, or the air/methane gas can be injected into the pressurized effluent flow via a venturi-type mixer-injector, to simultaneously withdraw the air/methane gas from the source and inject it into the mixer-injector.

Thus, methane gas contained in greenhouse gas emissions, including from septic systems, can be disposed of in subterranean disposal areas, thereby avoiding the environmental disadvantages of otherwise venting the greenhouse gases into the atmosphere. The methane gas can be broken down into carbon dioxide in the soil and used advantageously by crops or vegetation being irrigated. In some cases, it may be advantageous to apply the methane only at night as the plants absorb carbon dioxide at night.

These and other aspects of the invention will be more fully understood by referring to the following detailed description and the accompanying drawings.

### BRIEF DESCRIPTION OF THE DRAWINGS

FIG. 1 illustrates one embodiment of a methane gas disposal system, which comprises alternately drawing wastewater effluent and air/methane gas from a septic tank and dispersing them in the soil by pressure-dosing via a subsurface drip irrigation dispersal system.

FIG. 2 illustrates an alternative embodiment in which a venturi-type differential pressure injector is used to draw air/methane gas from a septic tank and simultaneously inject it into wastewater effluent passing from the septic tank to a subsurface drip irrigation dispersal system.

### DETAILED DESCRIPTION

The present invention provides a system for disposing of greenhouse gases containing methane. The methane-containing gases are collected from a source of methane gas emissions which are those produced by human activities, such as anaerobic digestion or fermentation which can produce large quantities of methane gas. Generally speaking, such methane gas emissions, which are commonly referred to as biogas, may contain methane gas as one of its components. The biogas emissions containing methane gas are collected or otherwise withdrawn from the source and then disposed of usefully as described below.

The sources of methane gas emissions to which the invention is directed can include anaerobic digesters including those on farms such as dairy farms; aerobic digestion facilities; lagoons, such as dairy lagoons; fermentation vessels, such as from wineries; food processing plants; and landfills. One significant source of environmental methane gas emissions is wastewater treatment or septic systems, and the following description will first emphasize one embodiment of the invention directed to a system for disposing of methane gas emissions from those sources.

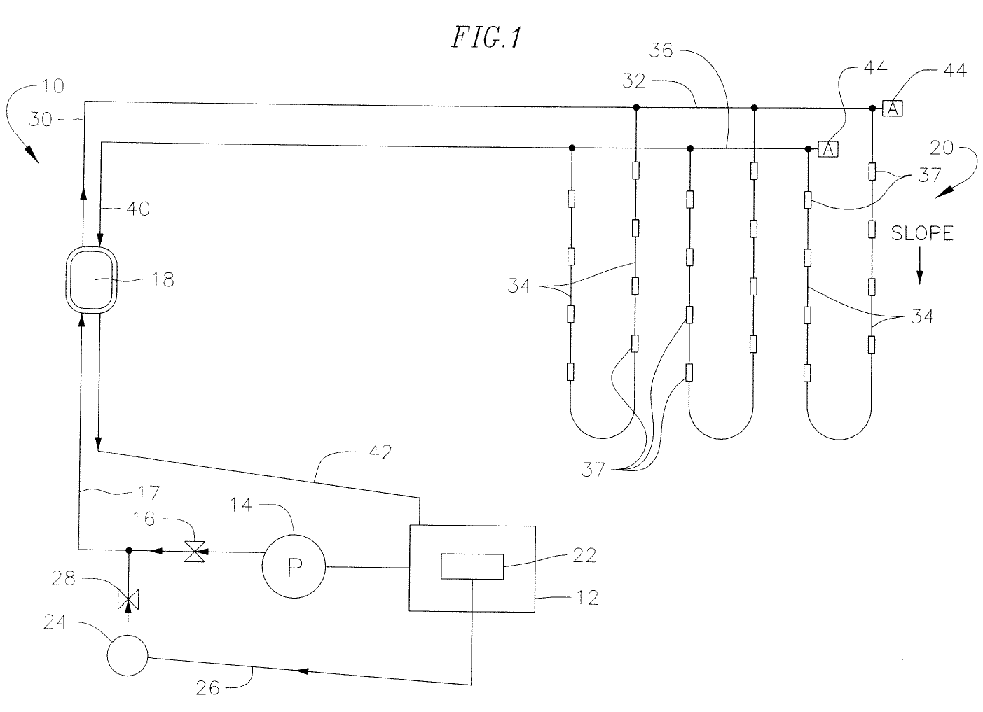

FIG. 1 illustrates one embodiment of a subsurface methane gas and wastewater disposal system 10 which includes a septic tank 12 having an inlet from a sewage influent source. The septic system generates sludge, wastewater effluent and also methane gas in the air above the effluent. The wastewater effluent, or secondary-treated effluent, is discharged to a drain field or leach field via a system of pumps, valves and filters in various forms known in the art.

FIG. 1 illustrates a simplified system which includes an effluent pump tank 14 having a pump which draws wastewater effluent from the septic tank and pumps it through a check valve 16 in a supply line 17 leading to headworks 18 and then into a downstream subsurface dispersal system 20 in a downstream drain field or leach field. The downstream dispersal system can comprise any one of several different types of subsurface dispersal systems.

In addition to the secondary-treated wastewater effluent, the system also disposes of the methane gas in the air at 22 above the interior of the septic tank. An air/methane pump 24 draws air from the top of the septic tank. The air containing methane gas is pumped through an air line 26 and injected into the supply line 17 leading to the drain field, controlled by a second check valve 28. In the description to follow, the term “air/methane gas” will be used to describe the gas contained generally within the volume or air space above the liquid effluent contained within the septic tank, which includes methane, along with other gases, as described in more detail below.

In the embodiment of FIG. 1, the effluent from the septic tank and the air/methane gas from the septic tank are alternately pumped into the supply line 17 via alternating dosing under the control of the check valves 16 and 28 and a controller (not shown).

The alternate timed dosing of septic tank effluent and air/methane gas is distributed through the supply line 17 to the headworks 18 positioned between the pressure tank 14 and the drain field. The headworks may comprise different options of pumps, valves and filters, but generally the headworks may include a vortex screen filter, filter flush valves and field flush valves. The headworks also may include pressure regulators to control pressure in downstream driplines when a drip irrigation emitter system is used in the subsurface disposal area. The wastewater disposal system 20 shown in the illustrated embodiment is available, for example, from Geoflow, Inc., Corte Madera, Calif., under the designation WASTEFLOW, and is described online via its “Subsurface Drip for On-Site Wastewater Reuse and Dispersal” guidelines at Geoflow.com.

The wastewater effluent and air/methane gas mixture are alternately pumped, via pressurized dosing, through a line 30 leading the subsurface dispersal system in the drain field. FIG. 1 illustrates one embodiment of the dispersal system, which includes a supply manifold 32 and an array of buried driplines 34 leading from the supply manifold to a return manifold 36. The driplines 34 include spaced apart drip irrigation emitters 37 which alternately disperse the effluent and air/methane gas to the soil. The emitters 37 can be any type of drip irrigation emitters or drippers, including turbulent flow drippers that emit water at a slow drip rate, or other openings in a dripline or tubing used for subsurface irrigation. The wastewater from time to time requires flushing of the drip emitters. Flushing in the dripper field occurs via a field flush valve at the headworks in a return line 40. The valve is normally closed but can be opened for returning effluent to the treatment tank 12 via a return line 42 during the flushing cycle.

The dispersal system also can include air/vacuum breakers 44 at the manifolds 32, 36 typically located at the high point of a slope, to avoid back-siphoning and soil ingestion in the emitters.

The buried dripline comprises a drip irrigation tubing containing the spaced apart drip emitters 37. The dripline can be drilled PVC pipe generally, or the type of drip irrigation tubing containing the drip emitters available from Geoflow for use with its WASTEFLOW wastewater reuse and dispersal system described previously. During use, the wastewater effluent emerges at a slow drip rate from the dripline through separate outlet holes in the drippers. Alternately, the air/methane gas that is pumped through the drip irrigation system, without any liquid, emerges from the drip emitters and is dispersed in the soil. The methane gas, which has been pumped through the drip system into the soil, will oxidize and break down into carbon, carbon dioxide and hydrogen gas. The methane is predominantly used by bacteria in the soil (methanotrophs), which use the methane as a source of carbon in a process called methane oxidation. In the subsurface drip system, alternating the air and methane mixture with the effluent can maintain aerobic conditions in the soil. Pretreatment of the effluent can ensure aerobic conditions in almost any soil. However, nitrogen is contained in sewage effluent, and a degree of denitrification may be used to produce a more aerobic condition in the effluent contained in the soil.

The techniques described above to remove methane can be used with any pressure-dosed effluent system, such as the drip irrigation dispersal system described above, or alternatively, any other subsurface timed dosing or discontinuous effluent dispersal system. These dispersal systems may include PVC pipes perforated with drainage holes, infiltrator tanks, a pressure dosed chambers system, or pressure dosed gravel trench system, for example.

The septic tank systems can vary, and in one embodiment, the septic tank comprises an on-site or decentralized system, where the methane source and dispersal area are located together; and one example would be a septic tank for residential use. This would include any septic system for which it is currently unfeasible economically to collect the methane gas for further use or sale.

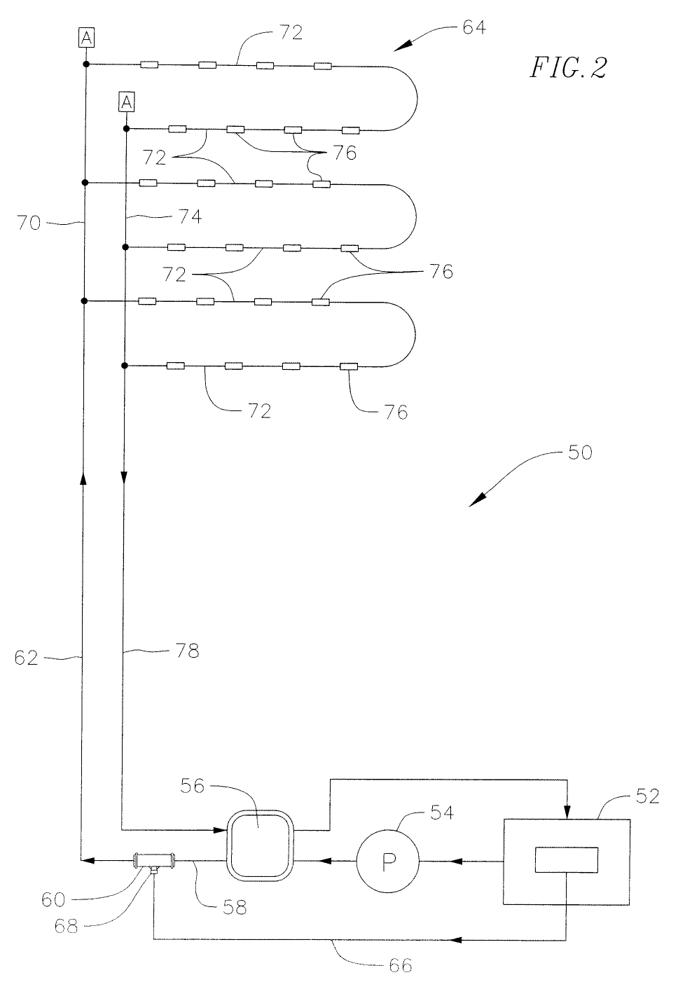

FIG. 2 illustrates an alternative embodiment of the invention in an effluent disposal system in which methane gas can be withdrawn from the septic tank and simultaneously injected into and mixed with the treated wastewater effluent, prior to disposal in the subsurface dispersal system. The FIG. 2 embodiment comprises a wastewater dispersal system 50 in which air/methane gas is drawn from a septic tank and injected into a pressurized stream of secondary-treated wastewater effluent passing from the septic tank to a subsurface drip irrigation dispersal system. This embodiment includes a septic tank 52 containing wastewater effluent, and also methane gas in the air contained within the tank. An effluent pump tank 54 draws wastewater effluent from the septic tank, and pumps it under pressure through a headworks 56 toward the downstream dispersal system. The headworks can be similar to those described previously, including various arrangements of pumps, valves, filters, and pressure regulators, familiar to those skilled in the art. In one embodiment, the headworks of FIG. 2 comprises Geoflow's WASTEFLOW system, described previously.

The wastewater continuously passes under pressure from the headworks 56 through a supply line 58, and into an inlet port of a venturi-type differential pressure injector 60. The pressurized wastewater passes through the main passageway in the injector, and out through the outlet port of the injector into a supply line 62 leading to a drainage field 64.

Separately, the air/methane gas contained within the septic tank is withdrawn from the septic tank through a gas supply line 66 and passed into a suction inlet 68 of the venturi-type injector. A sufficient pressure difference is generated between the inlet and outlet ports of the injector tube by the pressurized flow of wastewater effluent for producing a vacuum inside the injector body, which draws the air/methane gas in through the suction port of the injector.

The wastewater effluent functions as the carrier stream in the venturi. The air/methane gas is drawn into the carrier stream as an additive and is dispersed in a mixing operation in the pressurized wastewater flowing through the tube.

The injector can comprise various types of venturi-mixer-injectors, for producing suction for the additive stream of gas in response to a differential pressure generated in the carrier stream between the inlet and outlet ports of the injector. The venturi effect is produced, as is generally known, by the tapered structure in the throat section of the tube producing negative pressure which causes an aspiration of the additive material, discharging it into the throat section of the venturi.

In one embodiment, the injector 60 can comprise a mixer-injector as disclosed in U.S. Pat. No. 4,123,800 to Mazzei, which produces a turbulent effect to augment the mixing operation. (The mixer-injector as disclosed in the Mazzei '800 patent is incorporated herein by this reference.) However, as mentioned, other similar types of mixer-injectors can be used for drawing the air/methane gas from the septic tank and simultaneously injecting it into the pressurized wastewater flow continuously passing through the venturi.

The wastewater effluent and air/methane gas mixture are passed from the outlet of the injector 60 to the drainage field 64 via the supply line 62, under the pressure generated in the supply line by the pump 54. The dispersal system in the drainage field is similar to that described previously, and includes the supply manifold 70, the buried driplines 72, and the return manifold 74. The spaced apart drip irrigation emitters 76 contained in the buried driplines disperse the wastewater effluent and air/methane gas mixture into the soil. The wastewater effluent and air/methane gas mixture both can be, and usually will be periodically time dosed. Also, as mentioned previously, flushing of the system from time to time can be carried out by a field flush valve at the headworks 56 in a return line 78.

The septic gas disposal of the present invention can be useful in addressing problems associated with septic tank corrosion. The process of anaerobic digestion involves conversion of volatile organic acids into septic gas containing mostly methane, along with carbon dioxide, and trace amounts of water vapor, hydrogen sulfide, and ammonia. The hydrogen sulfide gas can convert to sulfuric acid, which corrodes the septic tank over time. Such corrosion problems can cause septic systems to be structurally unsound, and damaged cover plates also pose a danger to persons accidentally falling into corroded septic tanks. The toxic gases in the corroded system also create additional environmental problems.

The present invention removes the septic gas, including hydrogen sulfide, rapidly from the septic tank. Its continuous removal from the septic tank can prevent this type of deterioration and the associated risks.

The air/methane gas injected into the effluent and pumped through the drip system into the soil will oxidize and break down into carbon, carbon dioxide, and hydrogen gas. The air/methane gas supplied to the soil via the drip system can be used in a system for denitrification (removal of nitrogen) from the wastewater. In some applications, the methane gas can provide a carbon source for the denitrification process. The air/methane gas can be supplied to a biologically active region of the soil containing wastewater effluent to denitrify the effluent present in the soil. For example, the air/methane mixture can be used in a denitrification process by injecting it into wastewater present in an anaerobic condition, or in an aerobic condition, in the soil surrounding or adjacent to the dripline dispersal system. Wastewater effluent, from which excess nitrogen has previously been removed, in a separation process for example, can be treated by injecting the air/methane gas mixture into the soil containing such effluent.

In addition to the disposal of methane gas from anaerobic digesters or septic systems to wastewater drainage fields or leach fields, as described with reference to FIGS. 1 and 2, the invention also has useful applications to subterranean irrigation of crops or other vegetation in the disposal area. In this instance, the subterranean drip irrigation system can be located in disposal areas adjacent to various sources of methane gas emissions, so as to dispose of the methane gas by means other than dispersing it into the atmosphere. The sources of methane gas emissions can be those described previously, including wineries having a nearby vineyard, animal waste lagoons adjacent to farmland, and small sewage treatment plants surrounded by landscaped grounds.

In any of the various sources of methane gas emissions, such as those described previously, the methane gas can be collected from above the source, typically diluted with air. The inlet from a pump can be placed in the collection chamber, and in the case of a wine fermentation process, this is in the fermentation tank; in the case of a lagoon or landfill, one can place a bladder over the lagoon or landfill to entrap the gas and place the inlet to the pump inside the resulting chamber; and in the case of a small sewage treatment plant, the input to the pump can be placed above the anaerobic digester tank.

The subterranean drip irrigation disposal areas in these instances can be arranged for normally irrigating crops or vegetation by the drip irrigation techniques described previously. The methane gas can be transmitted to the drip irrigation field via the dripline tubing and emitters described previously, either by the dosing system of FIG. 1 or the injector system of FIG. 2. The system is advantageous because, when the methane is broken down in the soil into carbon dioxide as one of its by-products, the carbon dioxide can be absorbed into the leaves of the crops or other vegetation being irrigated. In one instance, experiments have shown that injecting carbon dioxide through a buried drip irrigation system can produce enhanced leaf growth and enrichment of vegetation, such as tomatoes, when the soil is enriched with carbon dioxide compared with the absence of carbon dioxide in the soil.

What is claimed is:

1. A system for disposing of methane gas comprising:
a chamber containing a source of anaerobic or fermentation activity producing an air/methane gas mixture contained within the chamber;
an irrigation disposal line leading to a subsurface irrigation dispersal system positioned in the soil in a subsurface disposal area; and
an air/methane gas supply line adapted for drawing the air/methane gas from the chamber and injecting the air/methane gas into the irrigation disposal line for passing the air/methane gas into the soil via the subsurface irrigation dispersal system.

2. The system according to claim 1 in which a subsurface irrigation dispersal system comprises one or more subsurface driplines containing spaced apart drip irrigation emitters for dispersing the air/methane gas into the soil.

3. The system according to claim 2 in which the subsurface disposal area comprises crops or vegetation irrigated by the subsurface driplines and emitters.

4. The system according to claim 3 in which the source of anaerobic or fermentation activity comprises a fermentation chamber, animal waste lagoon, landfill, or sewage treatment plant.

5. The system according to claim 1 in which the chamber comprises a septic tank; and in which the irrigation disposal line comprises a wastewater disposal line for passing wastewater from the septic tank to the subsurface irrigation dispersal system; and in which the septic tank is optionally a component of a decentralized sewage treatment system.

6. The system according to claim 5 including a time-dosed system of check valves for alternately drawing the effluent from the septic tank and the air/methane gas from the septic tank and alternately passing them through the wastewater disposal line.

7. The system according to claim 5 including a venturi-type mixer-injector for withdrawing the air/methane gas from the septic tank and simultaneously mixing the air/methane gas with the wastewater effluent in the mixer-injector prior to passing the mixture thereof to the subsurface dispersal system; and in which the mixer-injector optionally comprises a Mazzei mixer-injector.

8. A method for disposing a methane gas comprising:
providing a chamber containing a source of anaerobic or fermentation activity producing an air/methane gas mixture contained within the chamber,
providing an irrigation disposal line leading to a subsurface irrigation dispersal system positioned in the soil in a subsurface disposal area, and
drawing the air/methane gas from the septic tank and injecting the air/methane gas into the irrigation disposal line for passing the methane gas into the soil via the subsurface irrigation dispersal system.

9. The method according to claim 8 in which the subsurface dispersal system comprises an array of driplines and spaced apart drip irrigation emitters.

10. The method according to claim 9 in which the subsurface disposal area comprises crops or vegetation irrigated by the subsurface driplines and emitters.

11. The method according to claim 10 in which the source of anaerobic or fermentation activity comprises a fermentation chamber, animal waste lagoon, landfill, or sewage treatment plant.

12. The method according to claim 8 in which the chamber comprises a septic tank; and in which the irrigation disposal line comprises a wastewater disposal line for passing wastewater from the septic tank to the subsurface irrigation dispersal system; and in which the septic tank is optionally a component of a decentralized sewage treatment system.

13. The method according to claim 12 including alternately drawing the wastewater effluent from the septic tank and the air/methane gas from the septic tank and alternately passing them as separate doses through the disposal line.

14. The method according to claim 12 in which the wastewater effluent passes under pressure through a venturi-type mixer-injector which draws the air/methane gas from the septic tank and mixes the air/methane gas with the effluent prior to passing the mixture thereof to the dispersal system; and in which the mixer-injector optionally comprises a Mazzei mixer-injector.

15. The method according to claim 12 in which the air/methane gas is simultaneously withdrawn from the septic tank and mixed with the wastewater effluent prior to passing the mixture into the soil via the subsurface irrigation dispersal system.

16. A method for disposing of the methane gas contained in the air within a septic tank containing wastewater effluent, the method comprising separately withdrawing the wastewater effluent and the methane gas from the septic tank in a pressurized fluid flow system which delivers them to a subsurface wastewater dispersal system comprising an array of driplines containing drip irrigation emitters positioned in the soil at a wastewater disposal area; and in which the methane gas and the wastewater effluent are delivered to the disposal area independently, or in which the methane gas and the wastewater effluent are delivered to the disposal area by mixing them prior to passing the mixture thereof to the wastewater dispersal system.

17. The method according to claim 16 in which the disposal area comprises crops or vegetation irrigated by the wastewater effluent delivered to the dispersal system.

18. The method according to claim 17 in which the methane gas is withdrawn from the septic tank and simultaneously injected into a venturi-type mixer-injector prior to delivering the mixture to the dispersal system.

19. The method according to claim 17 including injecting the withdrawn methane gas into wastewater contained in the subsurface disposal area to denitrify the wastewater.

20. The method according to claim 17 in which the air and methane gas mixture contained within the septic tank contains hydrogen sulfide as a component, and is dispersed into the soil via the dispersal system.
